(19) United States
(12) Patent Application Publication
(10) Pub. No.: US 2026/0048483 A1
(43) Pub. Date: Feb. 19, 2026

(54) REPEATEDLY, QUICKLY AND DETACHABLY CONNECTABLE RETAINING MECHANISM

(71) Applicant: FOSITEK CORPORATION, NEW TAIPEI CITY (TW)

(72) Inventors: YA CHIH HUANG, NEW TAIPEI CITY (TW); HE YU KANG, NEW TAIPEI CITY (TW)

(21) Appl. No.: 18/826,536

(22) Filed: Sep. 6, 2024

(30) Foreign Application Priority Data
Aug. 13, 2024 (TW) 113130375

(51) Int. Cl. B25B 5/14

(52) U.S. Cl. CPC B25B 5/145

(57) ABSTRACT

A retaining mechanism consists of a seat including a curved support portion connected to a coupling portion for extending through an engaging slot on a substrate, and a clamp member slidably assembled to the seat. The coupling portion has an end provided with a retaining protrusion for protruding into a first end of the engaging slot and another end forming an elastic clamping section pressing on a bottom of the substrate. The seat further includes a holding section located corresponding to the retaining protrusion and a pressing section of the clamp member, so that a clamping opening is formed between the pressing section and the holding section for clamping an electronic card thereto. The holding section has a beveled outer edge retreated toward the support portion and the coupling portion to allow observation of the engagement of the retaining protrusion with the engaging slot from a top of the substrate.

### FIELD OF THE INVENTION

The present invention relates to a repeatedly, quickly and detachably connectable retaining mechanism, and more particularly, to an electronic card retaining mechanism that can be quickly connectable to and detachable from a substrate and securely held in place, and is easily observable to check a connecting state thereof.

### BACKGROUND OF THE INVENTION

General solid state drive with M.2 standard has various length specifications available for choosing, and the motherboard for a computer is also designed to have a plurality of fixing holes in response to the need of fixing solid state drives of different length specifications in place. Currently, as the most popular manner, the solid state drive is fastened to the computer motherboard by screws and bolts. However, the use of screws and bolts as fastening means will cause a lot of inconveniences in assembling and disassembling the solid state drives to and from the motherboard. Further, the bolts must be embedded in the computer motherboard in advance for the screws to fasten thereto. This would inevitably result in increased manufacturing cost. Therefore, it is an important issue for relevant manufacturers to workout a way of upgrading the efficiency in assembling the M.2 solid state drive to the motherboard while reducing the overall manufacturing cost.

FIGS. 1 and 2 show the structure of a repeatedly, quickly and removably connectable retaining mechanism disclosed in Taiwan Utility Model Publication No. M657887, which was filed by the same applicant of the present application and mainly includes a seat 1a for mounting on a substrate 3 that has an engaging slot 31 formed thereon. The seat 1a includes a post-like support portion 11a connected at a distal end to a middle section of an elongated coupling portion 12a, an end of which facing toward the seat 1a is provided with a retaining protrusion 13a. To mount the seat 1a of the retaining mechanism to the substrate 3, first obliquely extend the end of the coupling portion 12a having the retaining protrusion 13a through a first end of the engaging slot 31 to a lower side thereof, and then further extend another end of the coupling portion 12a through the engaging slot 31. Thereafter, displace the coupling portion 12a horizontally in a direction opposite to the retaining protrusion 13a, such that the retaining protrusion 13a is protruded upward into the first end of the engaging slot 31 while the support portion 11a is engaged with an opposite second end of the engaging slot 31, enabling the seat 1a to be held in place on the substrate 3.

In the above structure, the seat 1a has a top formed into a receiving space 14a, one side of which facing toward the retaining protrusion 13a is provided with a holding section 15a, a top of which defines a holding surface 16a. A sliding clamp member 20 is assembled to the receiving space 14a and is slidable reciprocatingly along a direction in which the coupling portion 12a extends. An end of the sliding clamp member 20 facing toward the holding section 15a is formed into a pressing section 202, which is slidable along with the sliding clamp member 20. The pressing section 202 cooperates with the holding surface 16a of the holding section 15a to hold and clamp an edge of an electronic card 4 therebetween.

The above structure has the following disadvantages in practical application thereof:
(1) When the seat 1a is mounted on the substrate 3, the retaining protrusion 13a is upward protruded into the first end of the engaging slot 31 from a bottom of the substrate 3 to thereby hold the seat 1a in place on the substrate. When it is desired to check whether the retaining protrusion 13a has been exactly located in the predetermined position in the engaging slot 31, a simple way is to observe the engaging slot 31 from a top of the substrate 3 to see whether the retaining protrusion 13a is located in the engaging slot 31 at the intended position. For this purpose, the holding section 15a of the seat 1a must be designed to project from the seat 1a by only a relatively short length to expose the first end of the engaging slot 31 from the substrate 3. With a shorter holding section 15a, the holding surface 16a might not be able to provide a deep enough space for clamping the edge of the electronic card 4 thereto. Therefore, the electronic card 4 being retained to the substrate 3 via the retaining mechanism is subject to shaking or even separation from the retaining mechanism during the process of installation, forming disadvantages in the design and practical application of the conventional electronic card retaining mechanism.
(2) The support portion 11a is in the form of a post and the coupling portion 12a is extended horizontally relative to the support portion 11a. When the seat 1a is assembled to the substrate 3, another end of the coupling portion 12a farther away from the retaining protrusion 13a is flatly attached to the bottom of the substrate 3 without providing any effect of elastically clamping on the substrate 3.
(3) When the support portion 11a is set in the engaging slot 31, the end of the coupling portion 12a opposite to the retaining protrusion 13a is flatly attached to the bottom of the substrate 3. When it is desired to detach the seat 1a from the substrate 3, the end of the seat 1a closer to the retaining protrusion 13a is tilted downward to separate from the first end of the engaging slot 31. This motion tends to cause breaking of the seat 1a at a junction of the coupling portion 12a and the support portion 11a because there is not a sufficient space allowing for the support portion 11a and the coupling portion 12a to move relative to the substrate 2.

Please refer to FIG. 3, which shows a variant of the embodiment shown in FIGS. 1 and 2. The variant embodiment of FIG. 3 includes a seat 1b and a slidable clamp member 20, which is identical to that in the previous embodiment. The seat 1b is structurally similar to the seat 1a but has a holding section 15b longer than the holding section 15a. The longer holding section 15b is projected outward to provide a relatively deep holding surface 16b sufficient for carrying an edge of the electronic card 4, so that the slidable clamp member 20 and the holding surface 16b together stably clamps the electronic card 4 in place between them.

However, the relatively long and outward projected holding structure 15b would block the engaging slot 31 from being seen from the top of the substrate 3, so that it is impossible to directly observe whether the retaining protrusion 13a has been exactly engaged with and held in the engaging slot or not.

In view of the disadvantages in the application of the conventional electronic card retaining device, it is tried by the inventor to develop an improved electronic card retaining mechanism.

### SUMMARY OF THE INVENTION

A primary object of the present invention is to provide a repeatedly, quickly and detachably connectable retaining mechanism, which includes a seat and a clamp member slidably connected to the seat. The seat includes a curved support portion extended from a bottom thereof to connect to a middle section of a coupling portion. The support portion is extendable through an engaging slot preformed on a substrate and the coupling portion follows the support portion to extend into the engaging slot with a retaining protrusion provided at an end thereof protruded into a first end of the engaging slot. The seat further includes a holding section located corresponding to the retaining protrusion. The clamp member is slidably assembled to the seat and includes a pressing section located corresponding to the holding section, so that a clamping opening is formed between the pressing section and the holding section for clamping an electronic card thereto. The holding section has an outer edge being a beveled surface retreated toward a junction of the support portion and the coupling portion, such that the engagement of the retaining protrusion with the engaging slot is observable from a top of the substrate when the seat is connected to the substrate.

Another object of the present invention is to provide the above repeatedly, quickly and detachably connectable retaining mechanism, the seat of which is assembled to the substrate with the retaining protrusion upward protruded into a first end of the engaging slot. The support portion is obliquely extended toward an opposite second end of the engaging slot, and the coupling portion has another end opposite to the retaining protrusion being configured for working with the seat to form an elastic clamping section for elastically abutting on a bottom of the substrate. A gap is left between the bottom of the substrate and a position at where the elastic clamping section and the support portion are connected together. When the seat is to be removed from the substrate, the gap provides a space that allows the end of the seat with the retaining protrusion to tilt downward and separate from the engaging slot, and the elastic clamping section is protected from breaking that would otherwise happen if there is not a space for it to move.

A further object of the present invention is to provide the above repeatedly, quickly and detachably connectable retaining mechanism, the clamp member of which has two laterally projected mating guide sections in the form of two projected pins integrally formed therewith. The mating guide sections are extendable into guide sections in the form of elongated slots correspondingly formed on the seat, so that the mating guide sections are slidably guided by the guide sections to connect to the seat with reduced parts and reduced production cost.

The structure and the technical means adopted by the present invention to achieve the above and other objects can be best understood by referring to the following detailed description of the preferred embodiments and the accompanying drawings.

### BRIEF DESCRIPTION OF THE DRAWINGS

Wherein:

FIG. 1 is an exploded perspective view of a repeatedly, quickly and removably connectable retaining mechanism, which is disclosed in Taiwan Utility Model Publication No. M657886 filed by the same applicant of the present invention;

FIG. 2 is an assembled sectional side view of the retaining mechanism of FIG. 1;

FIG. 3 is an assembled sectional side view of a variant embodiment of the retaining mechanism of FIG. 1;

FIG. 4 is an exploded perspective view of a repeatedly, quickly and detachably connectable retaining mechanism according to a preferred embodiment of the present invention;

FIG. 5 is an assembled view of FIG. 4 before being mounted to a substrate for retaining an electronic card thereto;

FIG. 6 is a first sectional side view showing the manner of connecting the retaining mechanism of the present invention to the substrate, in which the retaining mechanism is extended diagonally into an engaging slot on the substrate;

FIG. 7 is a second sectional side view showing the manner of connecting the retaining mechanism of the present invention to the substrate, in which the retaining mechanism has been extended through the engaging slot but not yet been positioned in place;

FIG. 8 is a third sectional side view showing the manner of connecting the retaining mechanism of the present invention to the substrate, in which the retaining mechanism is positioned in place in the engaging slot when a retaining protrusion on the retaining mechanism is protruded into a receiving section on the substrate;

FIG. 9 is a first sectional side view showing the use of the retaining mechanism of the present invention to retain the electronic card in place, in which the electronic card is just pressed downward to have an edge contacted with the retaining mechanism of the present invention;

FIG. 10 is a second sectional side view showing the use of the retaining mechanism of the present invention to retain the electronic card in place, in which the electronic card is pressed downward further to push a clamp member and compress a curved elastic section of the retaining mechanism;

FIG. 11 is a third sectional side view showing the use of the retaining mechanism of the present invention to retain the electronic card in place, in which the electronic card is fully pressed downward and clamped in place by the retaining mechanism; and

FIG. 12 is a fourth sectional side view showing the use of the retaining mechanism of the present invention to retain the electronic card in place, in which the electronic card is released from the retaining mechanism and springs back to an initial position before it is pressed downward.

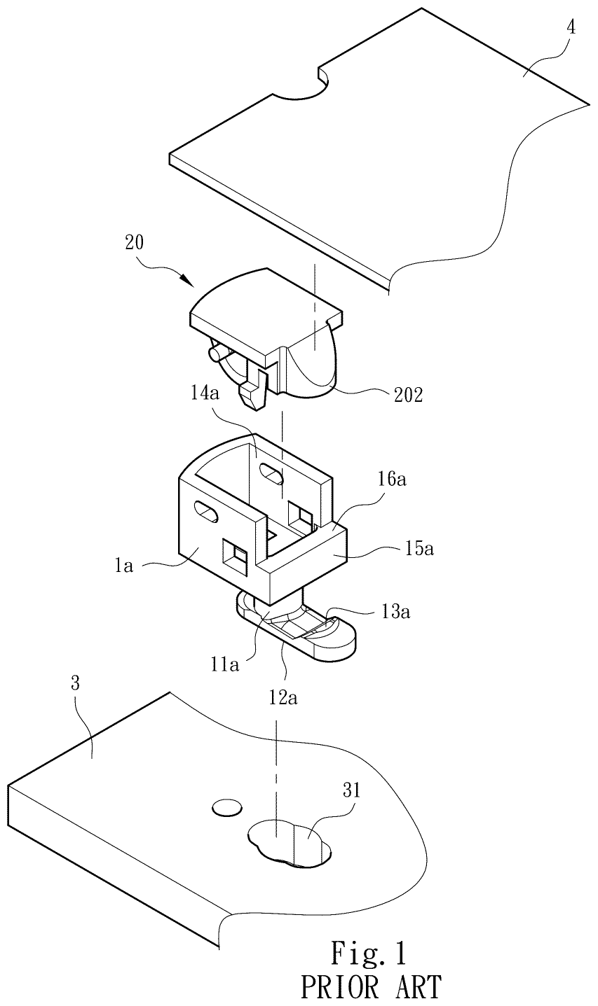

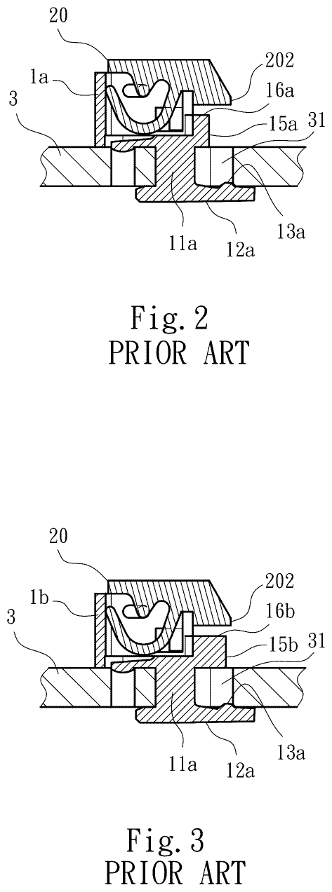

### DETAILED DESCRIPTION OF THE PREFERRED EMBODIMENTS

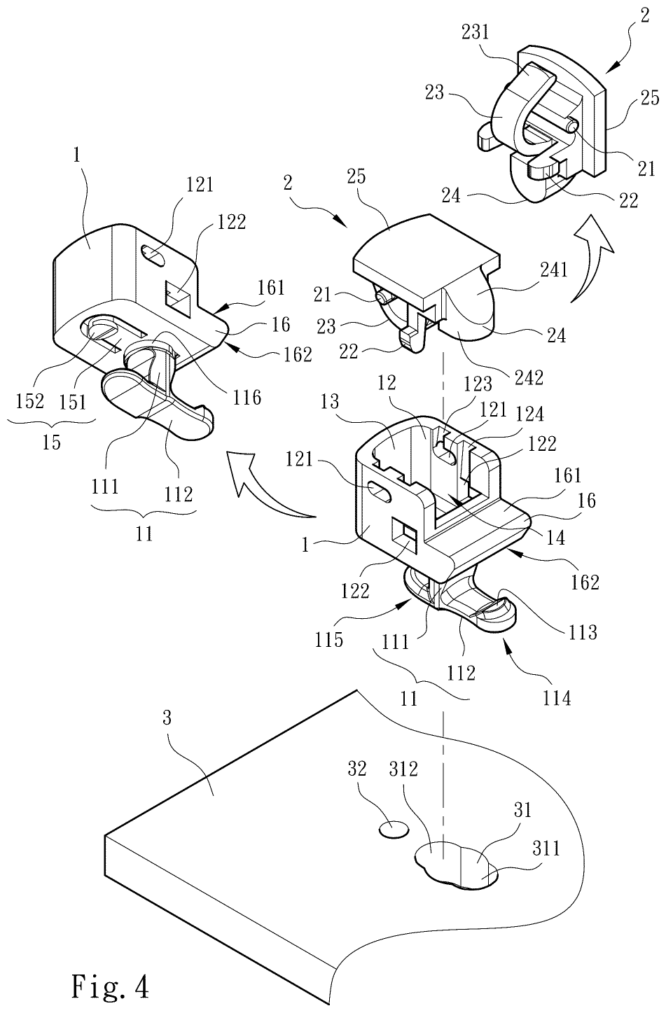

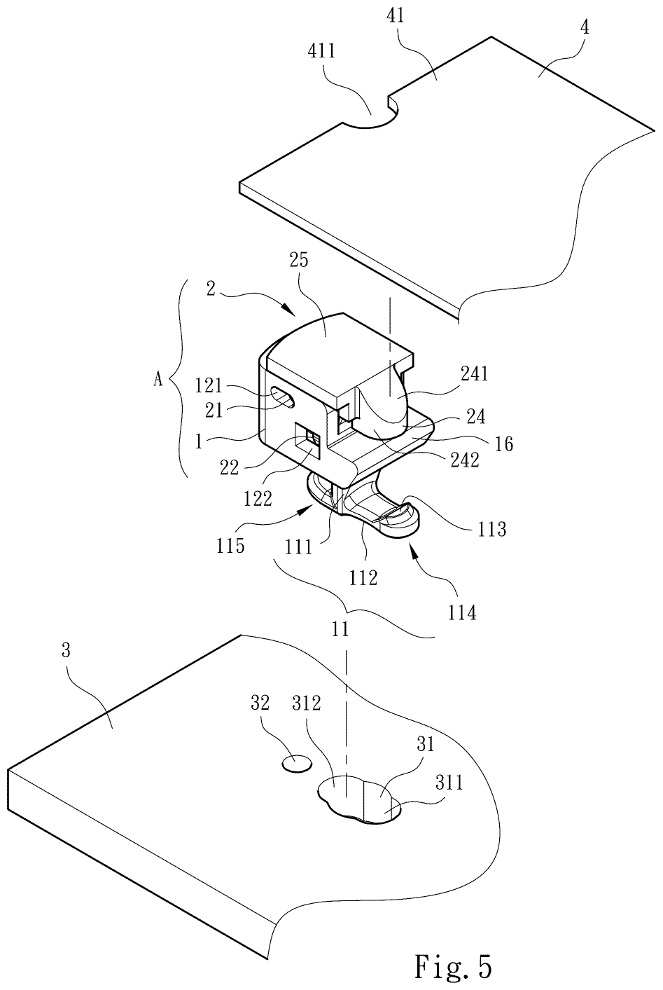

Please refer to FIGS. 4 to 6. The present invention provides a repeatedly, quickly and detachably connectable retaining mechanism A consisting of a seat 1 and a clamp member 2. The seat 1 includes a primary locating section 11 and a secondary locating section 15 located at a bottom thereof for engaging with an engaging slot 31 and an engaging hole 32 correspondingly provided on a substrate 3. The primary locating section 11 includes a support portion 111 having a curved contour. A proximal end of the support portion 11 connected to the seat 1 has an annular flange 116 formed around it; and a distal end of the support portion 11 farther away from the seat 1 is connected to a middle section of an elongated flexible coupling portion 112. The coupling portion 112 has two ends respectively being an extended section 114 and an elastic clamping section 115. One side of the extended section 114 facing toward the seat 1 is provided with a retaining protrusion 113. The secondary locating section 15 includes a spring plate 151, which extends in a direction parallel to the elastic clamping section 115 and is provided at an end with a locating protrusion 152 protruding toward the coupling portion 112. The engaging slot 31 is provided at a first end with a receiving section 311 corresponding to the retaining protrusion 113 and at an opposite second end with an abutting section 312.

In the above structure, the support portion 111 has a height slightly larger than a thickness of the substrate 3, and an included angle α between the support portion 111 and the bottom of the seat 1 is smaller than 90 degrees, such that the support portion 111 is extended slantly toward the elastic clamping section 115. Meanwhile, an included angle β between the support portion 111 and the elastic clamping section 115 is smaller than 90 degrees, such that the elastic clamping section 115 is extended slantly toward the bottom of the seat 1.

The seat 1 has a recessed receiving space 12 formed on a top thereof. An end of the receiving space 12 corresponding to the elastic clamping section 115 is provided with an inner stop surface 13; and another end of the receiving space 12 opposite to the inner stop surface 13 is provided with an end opening 14 corresponding to the extended section 114. A holding section 16 is formed on the seat 1 at an outer side of the end opening 14. The holding section 16 has a top serving as a holding surface 161, which has an outer edge formed into a beveled surface 162 retreated obliquely toward the support portion 111 and the coupling portion 112. At least one side or both sides of the receiving space 12 are provided with a guide section 121 and a limiting section 122 extending parallel to each other. In the illustrated preferred embodiment, the guide section 121 and the limiting section 122 are respectively an elongated hollow slot; and the guide section 121 is upward communicable with a guide slot 123, while the limiting section 122 is upward communicable with a limiting slot 124.

The clamp member 2 is partially received in the receiving space 12 and includes a push section 25 exposed from a top of the receiving space 12. The portion of the clamp member 2 extended into the receiving space 12 is provided on at least one side or both sides with a mating guide section 21 and a mating limiting section 22 for correspondingly engaging with the guide section 121 and the limiting section 122, respectively. Each mating guide section 21 is integrally formed with the clamp member 2 and is slidably extended into the corresponding guide section 121; and each mating limiting section 22 can be extended into and hooked to the corresponding limiting section 122, such that the mating limiting section 22 on one hand can slide relative to the limiting section 122 and on the other hand can prevent the clamp member 2 from moving out of the receiving space 12. In the illustrated preferred embodiment, the mating guide section 21 is in the form of a projected pin extendable into the elongated slot of the guide section 121, and the mating limiting section 22 is in the form of a hook extendable into the elongated guide slot of the limiting section 122 to hook thereto.

The clamp member 2 includes a curved elastic section 23 extending toward the inner stop surface 13. The curved elastic section 23 has a free end 231 elastically pressed against the inner stop surface 13. An end of the clamp member 2 opposite to the inner stop surface 13 is configured as a pressing section 24, which is protruded beyond the end opening 14 and has a top formed into a downward slanted beveled guide surface 241.

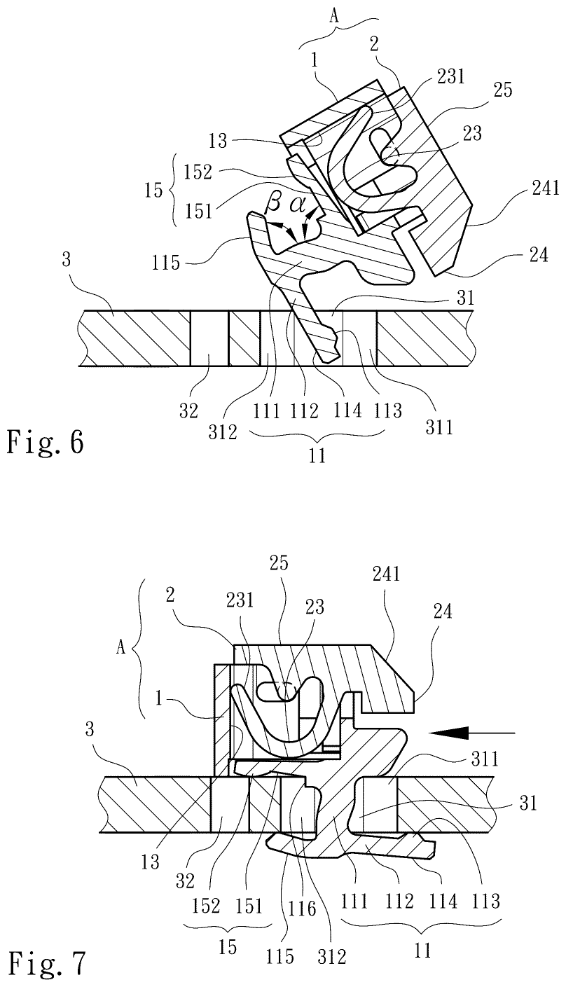

Please refer to FIGS. 6 to 8. To assemble the retaining mechanism A of the present invention, the mating guide sections 21 in the form of projected pins and the mating limiting sections 22 in the form of hooks are extended through the elongated slots of the guide sections 121 and the limiting sections 122 into the guide slots 123 and the limiting slots 124, respectively, such that the clamp member 2 is quickly and easily slidably connected to the seat 1.

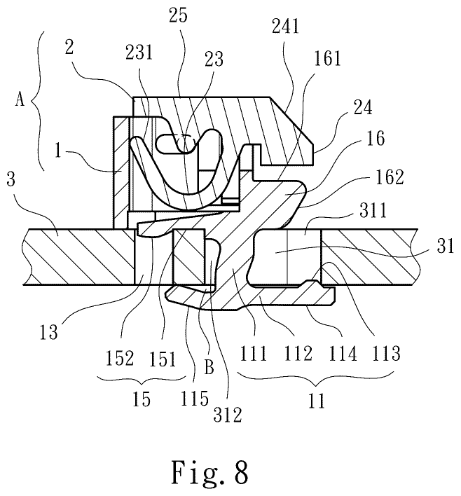

To connect the retaining mechanism A to the substrate 3, first obliquely extend the extended section 114 of the seat 1 through the engaging slot 31 to a lower side of the receiving section 311 as shown in FIG. 6. Then, extend the elastic clamping section 115 of the coupling portion 112 through the engaging slot 31 and move the seat 1 horizontally toward the abutting section 312 (i.e. an end of the engaging slot 31 opposite to the receiving section 311) as shown in FIG. 7, such that the annular flange 116 of the support portion 111 is abutted against the abutting section 312 while the retaining protrusion 113 on the extended section of the support portion 111 is protruded upward into the receiving section 311. Therefore, the seat 1 is held in place to the substrate 3. At this point, the elastic clamping section 115 extends obliquely to elastically press against and clamp to a lower side of the substrate 3, and a gap B is left between the lower side of the substrate 3 and a location at where the elastic clamping section 115 and the support portion 111 are joined. In this connection state, the locating protrusion 152 of the secondary locating section 15 is protruded downward into the engaging hole 32 on the substrate 3 to form an assistant locating mechanism to the primary locating section 11 for the seat 1 to be securely connected to the substrate 3, as shown in FIG. 8.

In the above structure, with the beveled surface 162 provided at the outer edge of the holding section 16 to retreat toward the support portion 111 and the coupling portion 112, the receiving section 311 of the engaging slot 31 is not blocked by the holding section 16 and visible from an outer side of the substrate 3 when the seat 1 is connected to the substrate 3. This structural design facilitates convenient observation of the retaining protrusion 113 from a position above the engaging slot 31 of the substrate 3, so as to check whether the retaining protrusion 113 has been exactly set in the receiving section 311 and accordingly, whether the seat 1 has been exactly connected to the substrate 3.

When it is desired to detach the retaining mechanism A from the substrate 3, first depress the seat 1 in an oblique direction for the retaining protrusion 113 to separate from the receiving section 311. At this point, the gap B provides a space for the elastic clamping section 115 to move in the engaging slot 31 without the risk of being broken. Then, push the retaining mechanism A toward the receiving section 311 to move the annular flange 116 away from the abutting section 312. Thereafter, the retaining mechanism A can be removed from the engaging slot 31 in a direction reverse to that shown in FIG. 6.

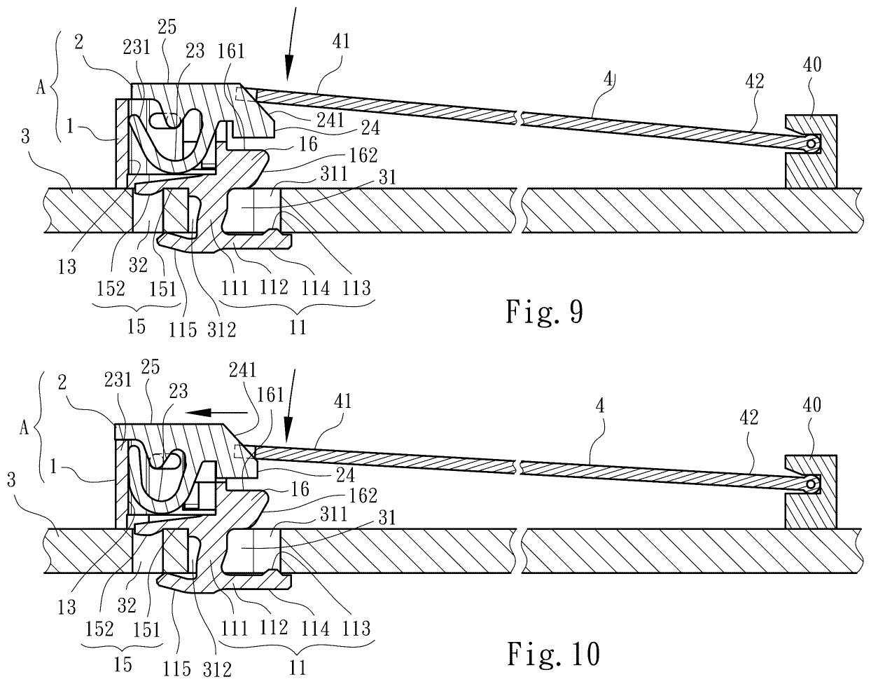

Please refer to FIGS. 9 to 12. In practical application of the present invention, an electronic card 4 (which can be a solid-state drive) can be installed on the substrate 3 via the retaining mechanism A. First, an electrically connecting end 42 of the electronic card 4 having terminal pins provided thereat is inserted into a terminal socket 40 provided on the substrate 3. Then, push downward an engaging end 41 at the other end of the electronic card 4 for the engaging end 41 to contact with the beveled guide surface 241 on the clamp member 2, as shown in FIG. 9, so as to slide the clamp member 2 toward the inner stop surface 13 to elastically compress and deform the curved elastic section 23, as shown in FIG. 10. In a feasible embodiment, the electronic card 4 includes a curved notch 411 provided on an edge of the engaging end 41, and the pressing section 24 of the clamp member 2 has a curved edge 242 corresponding to the curved notch 411. When the engaging end 41 of the electronic card 4 is downward pushed along the beveled guide surface 241 to pass through the pressing section 24, the curved edge 242 is fitted in the curved notch 411, so that the electronic card 4 is guided downward without shaking.

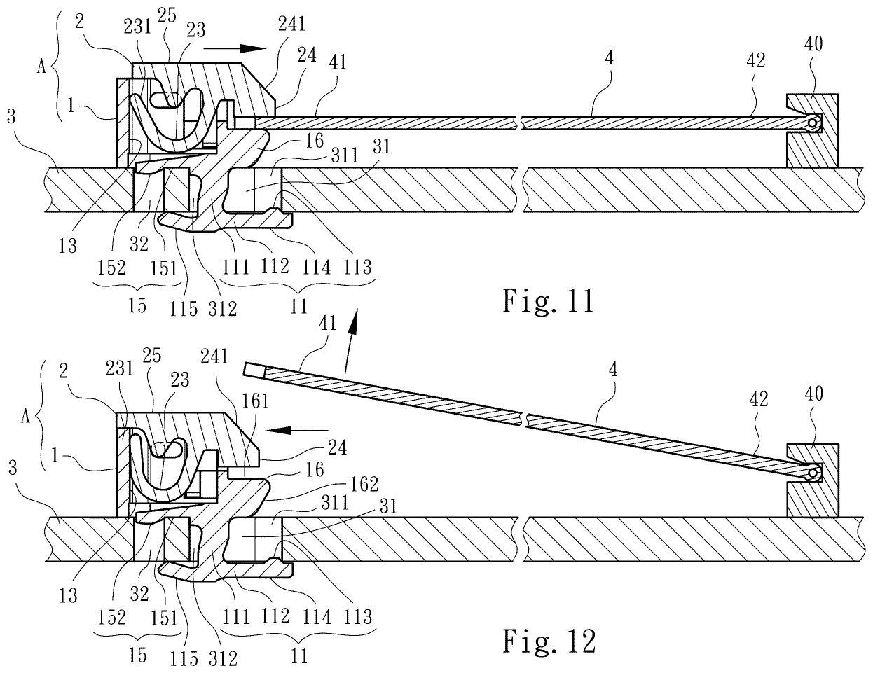

When the engaging end 41 of the electronic card 4 is downward pushed to move through the pressing section 24 to the holding surface 161 of the holding section 16, the holding surface 161 is long enough to stably hold the engaging edge 41 of the electronic card 4 thereto. Meanwhile, the clamp member 2 is moved away from the inner stop surface 13 back to its initial position under the elastic restoring force of the curved elastic section 23. Therefore, the pressing section 24 of the clamp member 2 is located above the edge of the engaging end 41 (i.e. above the notch 411) and the engaging end 41 of the electronic card 4 is clamped between the holding section 16 and the pressing section 24 at a position for use, as shown in FIG. 11.

On the other hand, when it is desired to remove the electronic card 4 from the substrate 3, simply apply a force to the push section 25 to slide the clamp member 2 toward the inner stop surface 13 and away from the electronic card 4. At this point, the curved elastic section 23 is compressed and elastically deformed, the pressing section 24 is separated from the notch 411 at the engaging end 41, and the electronic card 4 is no longer clamped between the pressing section 24 and the holding section 16. Meanwhile, due to an elastic force applied by the terminal socket 40 to the electrically connecting end 42, the engaging end 41 of the electronic card 4 that has been released from the holding surface 161 springs upward automatically to a position that facilitates easy removal of the electronic card 4 from the retaining mechanism A and the substrate 3, as shown in FIG. 12. When the force applied to the push section 25 is removed, the clamp member 2 is sprung back to its initial position under the elastic restoring force of the curved elastic section 23.

With the above structure, the retaining mechanism A of the present invention has the following advantages:
(1) With the beveled surface 162 of the holding section 16 that is retreated from the outer edge of the holding section 16 toward the support portion 111, the receiving section 311 of the engaging slot 31 is visible from an outer side of the substrate 3 to facilitate convenient observation of the engaging state of the retaining protrusion 113 with the receiving section 311, so as to confirm the seat 1 of the retaining mechanism A has been exactly connected to the substrate 3. Thus, the present invention is convenient for assembling to the substrate 3.
(2) The elastic clamping section 115 is configured to extend obliquely toward the bottom of the seat 1, so that the elastic clamping section 115 on one hand can clamp to the bottom of the substrate 3 to enhance the locating of the seat 1 to the substrate 3, and on the other hand can provide a gap B between the bottom of the substrate 3 and a location at where the elastic clamping section 115 and the support portion 111 are connected together. The gap B provides the elastic clamping section 115 with a space to curve and move in the process of detaching the retaining mechanism A from the substrate 3, so that the elastic clamping section 115 is prevented from being broken.
(3) The mating guide sections 21 in the form of projected pins can be integrally formed with the clamp member 2 to reduce the number of parts of the clamp member 2 and accordingly, reduce the production cost of the retaining mechanism A.

According to the above discussion, the retaining mechanism of the present invention indeed has the advantages of being repeatedly, quickly and detachably connectable to a substrate and providing secure and observable assembling of the retaining mechanism to the substrate. Therefore, the present invention meets the requirements of novelty and improvement for granting a patent. It is also understood the present invention has been described with a preferred embodiment thereof and it is understood that many changes and modifications in the described embodiment can be carried out without departing from the scope and the spirit of the invention that is intended to be limited only by the appended claims.

What is claimed is:

1. A retaining mechanism (A) being repeatedly, quickly and detachably connectable to a substrate (3), comprising:
a seat (1) including a support portion (111) extended from a bottom of the seat (1) to connect to a middle section of a horizontally extended coupling portion (112); the coupling portion (112) having an end formed into an extended section (114) provided with a retaining protrusion (113); the retaining protrusion (113) being brought by the support portion (111) to engage with a first end of an engaging slot (31) preformed on the substrate (3); the seat (1) having a recessed receiving space (12) formed on a top thereof, one side of the receiving space (12) facing toward the retaining protrusion (113) being an end opening (14) communicable with an outer side of the retaining mechanism (A); a holding section (16) being formed on the seat (1) at an outer side of the end opening (14) and having an outer edge formed into a beveled surface (162), which is retreated obliquely toward the support portion (111) and the coupling portion (112); and with the beveled surface (162), the first end of the engaging slot (31) having the retaining protrusion (113) protruded thereinto being visible from an outer side of the substrate (3) without being blocked by the holding section (16); and
a clamp member (2) being partially received in the receiving space (12) and having a pressing section (24) formed on an end thereof corresponding to the holding section (16).

2. The retaining mechanism as claimed in claim 1, wherein the clamp member (2) has another end which is located opposite to the pressing section (24) to elastically press against one side of the receiving space (12) opposite to the end opening (14), such that the clamp member (2) is normally elastically pushed toward the holding section (16).

3. The retaining mechanism as claimed in claim 2, wherein the coupling portion (112) includes an elastic clamping section (115) located at an end opposite to the retaining protrusion (113); the support portion (111) and the bottom of the seat (1) together defining an included angle smaller than 90 degrees, such that the support portion (111) is extended slantly toward the elastic clamping section (115); and the support portion (111) and the elastic clamping section (115) together defining an included angle also smaller than 90 degrees, such that the elastic clamping section (115) is extended slantly toward the bottom of the seat (1).

4. The retaining mechanism as claimed in claim 3, wherein the support portion (111) has a height larger than a thickness of the substrate (3), such that a gap (B) is left between the bottom of the seat (1) and a position at where the support portion (111) is connected to the elastic clamping section (115).

5. The retaining mechanism as claimed in claim 1, wherein the holding section (16) includes a holding surface (161) formed on one side facing toward the clamp member (2); and the holding surface (161) and the pressing section (24) together define a clamping space between them for clamping an electronic card (4) thereto.

6. The retaining mechanism as claimed in claim 1, wherein the seat (1) is provided on two lateral sides of the receiving space (12) with at least one guide section (121) and at least one limiting section (122) extending parallel to the guide section (121), and the clamp member (2) is correspondingly provided with at least one mating guide section (21) and at least one mating limiting section (22); the mating guide section (21) being integrally formed with the clamp member (2) and extended into and guided by the guide section (121) to move slidably; and the mating limiting section (22) being extendable into and hooked to the limiting section (122) to be guided by the limiting section (122) to move slidably while preventing the clamp member (2) from moving out of the receiving space (12).

7. The retaining mechanism as claimed in claim 2, wherein the seat (1) is provided on two lateral sides of the receiving space (12) with at least one guide section (121) and at least one limiting section (122) extending parallel to the guide section (121), and the clamp member (2) is correspondingly provided with at least one mating guide section (21) and at least one mating limiting section (22); the mating guide section (21) being integrally formed with the clamp member (2) and extended into and guided by the guide section (121) to move slidably; and the mating limiting section (22) being extendable into and hooked to the limiting section (122) to be guided by the limiting section (122) to move slidably while preventing the clamp member (2) from moving out of the receiving space (12).

8. The retaining mechanism as claimed in claim 1, wherein the clamp member (2) includes a curved elastic section (23) extended toward and elastically pressed against one side of the receiving space (12) opposite to the end opening (14); and the clamp member (2) further including a push section (25) exposed from a top of the receiving space (12).

9. The retaining mechanism as claimed in claim 2, wherein the clamp member (2) includes a curved elastic section (23) extended toward and elastically pressed against one side of the receiving space (12) opposite to the end opening (14); and the clamp member (2) further including a push section (25) exposed from a top of the receiving space (12).

10. The retaining mechanism as claimed in claim 6, wherein the clamp member (2) includes a curved elastic section (23) extended toward and elastically pressed against one side of the receiving space (12) opposite to the end opening (14); and the clamp member (2) further including a push section (25) exposed from a top of the receiving space (12).

11. The retaining mechanism as claimed in claim 1, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).

12. The retaining mechanism as claimed in claim 2, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).

13. The retaining mechanism as claimed in claim 3, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).

14. The retaining mechanism as claimed in claim 4, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).

15. The retaining mechanism as claimed in claim 6, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).

16. The retaining mechanism as claimed in claim 8, wherein the substrate (3) further includes an engaging hole (32) located at one side of the engaging slot (31), and the seat (1) is provided on the bottom thereof with a secondary locating section (15); the secondary locating section (15) including a spring plate (151), which is provided at an end with a locating protrusion (152) to protrude toward the coupling portion (112); and the locating protrusion (152) being engaged with the engaging hole (32) when the seat (1) is fully assembled to the substrate (3).
